(19) United States
(12) Patent Application Publication
(10) Pub. No.: US 2017/0321124 A1
(43) Pub. Date: Nov. 9, 2017

(54) HIGH-EFFICIENCY PYROLYSIS APPARATUS

(71) Applicants: CHUNG-LONG HSU, Miaoli County (TW); SHU-HUI HSU, Hsinchu County (TW)

(72) Inventors: CHUNG-LONG HSU, Miaoli County (TW); SHU-HUI HSU, Hsinchu County (TW)

(21) Appl. No.: 15/147,213

(22) Filed: May 5, 2016

(51) Int. Cl. C10B 53/07; B01D 3/14; C10B 1/04; C10B 19/00

(52) U.S. Cl. CPC C10B 53/07; C10B 19/00; B01D 3/143; C10B 1/04

(57) ABSTRACT

A high-efficiency pyrolysis apparatus comprises a first pyrolysis furnace, a second pyrolysis furnace, a fractional distillation device, and an air sucking device. The first pyrolysis furnace heats and pyrolyzes a solid-state waste. The second pyrolysis furnace interconnects with the first pyrolysis furnace through a first channel and generates a fluid. The fractional distillation device interconnects with the second pyrolysis furnace through a second channel and performs a fluid separation operation on the fluid. The air sucking device interconnects with the first pyrolysis furnace and generates a negative pressure to the first channel and the second channel to prevent from that air exists in the first pyrolysis furnace and the second pyrolysis furnace and that toxic materials are generated in the first pyrolysis furnace and the second pyrolysis furnace. The high-efficiency pyrolysis apparatus is less likely to generate toxic materials and thus less likely to pollute the air.

### FIELD OF THE INVENTION

The present invention relates to a pyrolysis apparatus, particularly to a high-efficiency pyrolysis apparatus.

### BACKGROUND OF THE INVENTION

The pyrolysis furnace is a furnace using high temperature to convert one material into another material, for example, converting wood into solid-state carbon, liquid-state oil and gas-state combustible gas. Pyrolysis furnaces are often used in the field needing high-temperature heating, such as the petrochemical industry, the semiconductor industry, and the energy regeneration industry.

A Taiwan patent No. TW191884 disclosed a multifunctional mass-burning incinerator, which comprises a primary combustion chamber, a liquid combustion chamber, a secondary combustion chamber, and a blower. The primary combustion chamber is used to burn solid-state waste. The liquid combustion chamber is used to burn the organic waste in the liquid waste exhausted by the primary combustion chamber. The secondary combustion chamber is used to burn the waste gas exhausted by the liquid combustion chamber more completely. The blower is used to recycle the gas exhausted by the secondary combustion chamber through a hot air duct back to the primary combustion chamber for recombustion.

A U.S. Pat. No. 7,318,382B2 disclosed a “Method for Incineration Disposal of Waste”, which uses an apparatus comprising a gasification furnace, a combustion furnace, an air blower fan, and a controller. The controller controls a valve actuator to operate a control valve, so that the oxygen or air in a first air supply channel is driven into the gasification furnace by the air blower fan. The controller also controls another valve actuator to operate another control valve, so that the oxygen or air in a third air supply channel is driven into the combustion furnace by the air blow fan.

In the abovementioned conventional technologies, the combustion furnace undertakes combustion under an atmospheric pressure. However, toxic materials are generated by chemical reactions in the heating process thereof because the heated materials contact air. Therefore, the conventional technologies are likely to generate air pollution and endanger health of living bodies.

### SUMMARY OF THE INVENTION

The primary objective of the present invention is to solve the problem that the conventional combustion furnaces normally operate under an atmospheric pressure and are likely to generate toxic materials polluting the air and endanger living bodies.

In order to achieve the abovementioned objective, the present invention proposes a high-efficiency pyrolysis apparatus, which comprises a first pyrolysis furnace, a second pyrolysis furnace, a fractional distillation device and an air sucking device. The first pyrolysis furnace includes a first chamber and a first heater arranged inside the first chamber. The first heater is selected from a group including resistance heaters, inductive heaters, and electron-beam heaters. The first heater generates a first heating temperature of 100-2000° C. in the first chamber to pyrolyze a waste. The second pyrolysis furnace interconnects with the first pyrolysis through a first channel and includes a second chamber and a second heater arranged inside the second chamber. The second heater is selected from a group including resistance heaters, inductive heaters, and electron-beam heaters. The second heater generates a second heating temperature of 100-2000° C. in the second chamber to generate a fluid. The second heating temperature is higher than the first heating temperature. The fractional distillation device interconnects with the second pyrolysis furnace through a second channel. The fluid is transferred through the second channel to the fractional distillation device and fractionally distilled therein. A specified portion of the fluid is separated and recycled. The air sucking device interconnects with the first pyrolysis furnace and generates a negative pressure to the first channel and the second channel lest air exist in the first pyrolysis furnace and the second pyrolysis furnace. Thereby is avoided generation of toxic materials.

In comparison with the conventional technologies, the present invention has the efficacy that the pyrolysis furnaces are persistently vacuated and maintained at a negative pressure to prevent heated waste from contacting air and generating toxic materials.

### BRIEF DESCRIPTION OF THE DRAWINGS

FIG. 1 is a diagram schematically showing a high-efficiency pyrolysis apparatus according to one embodiment of the present invention; and

FIG. 2 is a diagram schematically showing a high-efficiency pyrolysis apparatus according to another embodiment of the present invention.

### DETAILED DESCRIPTION OF THE PREFERRED EMBODIMENTS

The technical contents of the present invention will be described in detail in cooperation with the attached drawings below.

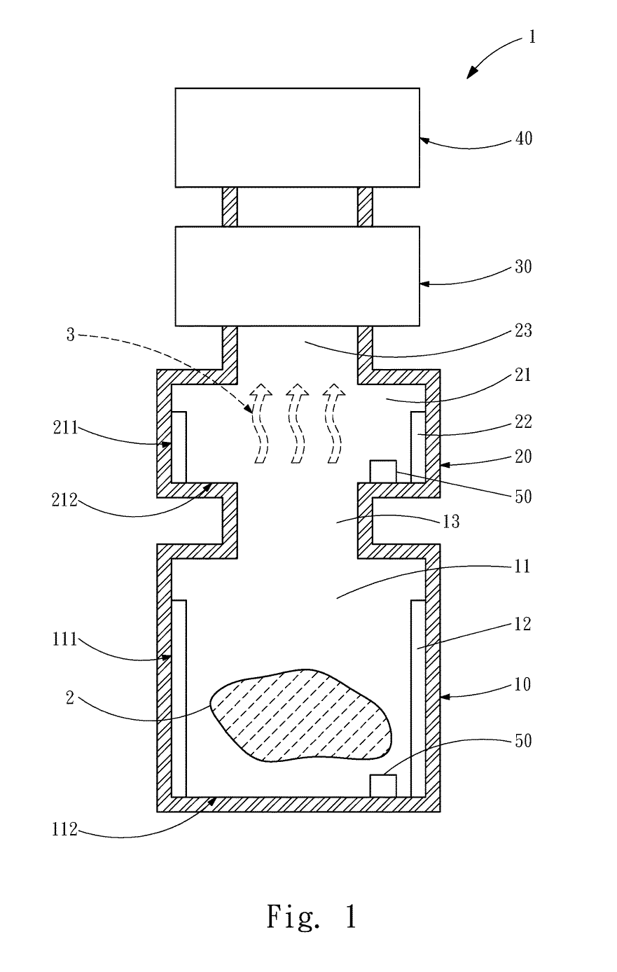

Refer to FIG. 1 a diagram schematically showing a high-efficiency pyrolysis apparatus according to one embodiment of the present invention. The high-efficiency pyrolysis apparatus 1 of the present invention comprises a first pyrolysis furnace 10, a second pyrolysis furnace 20, a fractional distillation device 30, and an air sucking device 40. The first pyrolysis furnace 10 interconnects with the second pyrolysis furnace 20 through a first channel 13. The fractional distillation device 30 interconnects with the second pyrolysis furnace 20 through a second channel 23. The air sucking device 40 interconnects with the first pyrolysis furnace 10. The first pyrolysis furnace 10 includes a first chamber 11 and a first heater 12 arranged inside the first chamber 11. The first heater 12 is selected from a group including resistance heaters, inductive heaters, electron-beam heaters and combinations thereof. The first heater 12 generates a first heating temperature of 100-2000° C. in the first chamber 11.

In the embodiment shown in FIG. 1, the second pyrolysis furnace 20 is arranged above the first pyrolysis furnace 10 and includes a second chamber 21 and a second heater 22 arranged inside the second chamber 21. The second heater 22 is selected from a group including resistance heaters, inductive heaters, electron-beam heaters, and combinations thereof. The second heater 22 generates a second heating temperature of 100-2000° C. in the second chamber 21. In the present invention, the second heating temperature is higher than the first heating temperature. The first chamber 11 includes a first inner side wall 111 and a first inner bottom wall 112. The second chamber 21 includes a second inner side wall 211 and a second inner bottom wall 212. In one embodiment, the first heater 12 and the second heater 22 are respectively disposed in the first inner side wall 111 and the second inner side wall 211. In one embodiment, the first heater 12 and the second heater 22 respectively protrude upward from the first inner bottom wall 112 and the second inner bottom wall 212. The abovementioned embodiments are only to exemplify the present invention but not to limit the scope of the present invention. The first heater 12 and the second heater 22 can be disposed in any position according to requirement as long as they can heat materials uniformly.

In one embodiment, the fractional distillation device 30 is a fractionating column, and the air sucking device 40 is a vacuum pump. In operation, a solid-state waste 2 is placed inside the first chamber 11 of the first pyrolysis furnace 10. The first heater 12 heats the solid-state waste 2 inside the first chamber 11 to a first heating temperature to make the solid-state waste 2 partially or completely decompose. The decomposed solid-state waste 2 forms a fluid 3. The fluid 3 is a liquid or a gas. The air sucking device 40 makes the fluid 3 flow to the second chamber 21. The second heater 22 heats the fluid 3 inside the second chamber 21 to a second heating temperature to decompose the fluid 3. Then, the fluid 3 flows through the second channel 23 into the fractional distillation device 30 for fluid separation. A specified portion of the fluid 3 is separated and recycled. The air sucking device 40 interconnects with the first pyrolysis furnace 10 and generates a negative pressure to the first channel 13 and the second channel 23. In the present invention, the air sucking device 40 succeeds to the second pyrolysis furnace 20 or the fractional distillation device 30, whereby to decrease the air content of the first chamber 11 and the second chamber 21. Thus, during the decomposition, the solid-state waste 2 and the fluid 3 are isolated from the air, and toxic materials are likely to be generated. Besides, the negative pressure can drive the fluid 3 to flow and increase the efficiency of pyrolysis.

In one embodiment, the high-efficiency pyrolysis apparatus 1 of the present invention further comprises at least one detector 50 respectively disposed in the first pyrolysis furnace 10 and the second pyrolysis furnace 20. The detector 50 may be a gas detector, a temperature detector, a weight detector, or a combination thereof. For example, the gas detector, the temperature detector and the weight detector are disposed in the first chamber 11; the weight detector is used to determine the weight or proportion of the decomposed solid-state waste 2; the temperature detector is used to detect the value of the first heating temperature; the gas detector is used to detect the status of the decomposition of the solid-state waste 2.

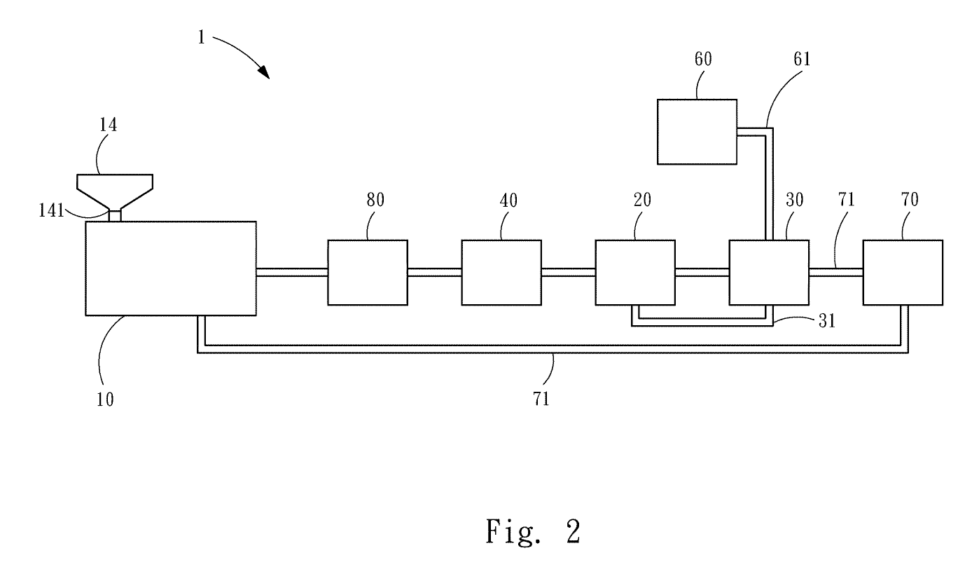

Refer to FIG. 2, and refer to FIG. 1 again. In the embodiment shown in FIG. 2, the first pyrolysis furnace 10 further includes a collector 14. The collector 14 includes a switch 141 connected with the first pyrolysis furnace 10 and interconnecting with the top of the first chamber 11. While the first pyrolysis furnace 10 undertakes a heating operation, the switch 141 is turned off to make the first chamber 11 of the first pyrolysis furnace 10 isolated from the collector 14. After the heating operation is completed, the switch 141 is turned on to make the first chamber 11 of the first pyrolysis furnace 10 interconnect with the collector 14. Then, a driving assembly turns the first pyrolysis furnace 10 upside down. Thus, the residues inside the first pyrolysis furnace 10 gravitationally fall into the collector 14. In the present invention, the collector 14 can be taken off from the first pyrolysis furnace 10. The residues inside the collector 14 is poured into a residue collection unit for convenient transportation. In one embodiment, the residue collection unit is a plastic bag. While used to process carbon-containing materials, such as polymers or hydrocarbons, the high-efficiency pyrolysis apparatus 1 of the present invention can convert the carbon-containing materials into high heating value carbon, active carbon, graphite, graphene or other reusable materials and collect the reusable materials in the collector 14. Thus, the high-efficiency pyrolysis apparatus 1 can also function as a resource-recycling apparatus.

In the embodiment shown in FIG. 2, the high-efficiency pyrolysis apparatus 1 of the present invention further comprises a first recycling pipe 31 disposed between the second pyrolysis furnace 20 and the fractional distillation device 30. The first recycling pipe 31 is used to recycle a residual fluid, which is not completely burned in the second pyrolysis furnace 20, back to the second pyrolysis furnace 20 for recombustion lest the residual fluid flow out of the high-efficiency pyrolysis apparatus 1 and generate air pollution. In the embodiment shown in FIG. 2, the high-efficiency pyrolysis apparatus 1 of the present invention further comprises a waste water collector 60, a fluid supply device 70 and a dust collector 80. The waste water collector 60 interconnects with the fractional distillation device 30 through a second recycling pipe 61 and collects waste water generated by the fractional distillation device 30. In one embodiment, the fluid supply device 70 interconnects with the first pyrolysis furnace 10 through a fluid pipe 71. The fluid pipe 71 directly or indirectly contacts the first heater 12, whereby the there is a thermal contact between the first heater 12 and a thermal-conduction fluid supplied by the fluid supply device 70. In this embodiment, the thermal-conduction fluid is used to assist the first heater 12 in heating or cooling. While the first heater 12 undertakes heating, the fluid supply device 70 supplies the thermal-conduction fluid to the first pyrolysis furnace 10 through the fluid pipe 71. Thus, thermal contact occurs between the thermal-conduction fluid and a plurality of heating assemblies of the first heater 12, assisting thermal energy to propagate and distribute uniformly in the heating assemblies. While the first heater 12 undertakes cooling, the thermal-conduction fluid assists thermal energy to leave the first heater 12. In one embodiment, the fluid pipe 71 is further connected with the fractional distillation device 30 and supplies a cooling fluid to assist the fractional distillation device 30 in cooling. The dust collector 80 interconnects with the first pyrolysis furnace 10. During operation of the high-efficiency pyrolysis apparatus 1, the dust collector 80 filters high-temperature dust lest the high-temperature dust pollute the high-efficiency pyrolysis apparatus 1.

In the present invention, the pyrolysis furnaces operate not under an atmospheric pressure but under persistently vacuum-pumped environment. Therefore, the present invention can prevent the heated waste from contacting the air and generating toxic materials that pollute the air and endanger health of living bodies. Further, the present invention does not use fuel gas, heavy fuel oil or coal, which would seriously pollute the environment, but adopts resistance heaters, inductive heaters, or electron-beam heaters. Therefore, the present invention can obviously reduce environmental pollution.

The present invention has been described in detail with the embodiments above. However, these embodiments are only to exemplify the present invention but not to limit the scope of the present invention. Any equivalent modification or variation according to the spirit of the present invention is to be also included within the scope of the present invention.

What is claimed is:

1. A high-efficiency pyrolysis apparatus, comprising
a first pyrolysis furnace, including a first chamber and a first heater arranged inside the first chamber, selected from the group including resistance heaters, inductive heaters and electron-beam heaters, generating a first heating temperature of 100-2000° C. in the first chamber to pyrolyze a solid-state waste;
a second pyrolysis furnace, interconnecting with the first pyrolysis furnace through a first channel, including a second chamber and a second heater arranged inside the second chamber, selected from the group including resistance heaters, inductive heaters and electron-beam heaters, generating a second heating temperature of 100-2000° C. in the second chamber to generate a fluid, wherein the second heating temperature is higher than the first heating temperature;
a fractional distillation device, interconnecting with the second pyrolysis furnace through a second channel, wherein the fluid is transferred to the fractional distillation device for a separation operation, and wherein a specified portion of the fluid is separated and recycled; and
an air sucking device, interconnecting with the first pyrolysis furnace and generating a negative pressure to the first channel and the second channel to prevent from that air exists in the first pyrolysis furnace and the second pyrolysis furnace and that toxic materials are generated in the first pyrolysis furnace and the second pyrolysis furnace.

2. The high-efficiency pyrolysis apparatus according to claim 1, wherein the first chamber and the second chamber respectively include a first inner side wall and a second inner side wall, and wherein the first heater and the second heater are respectively disposed in the first inner side wall and the second side wall.

3. The high-efficiency pyrolysis apparatus according to claim 1, wherein the first chamber and the second chamber respectively include a first inner bottom wall and a second inner bottom wall, and wherein the first heater and the second heater respectively protrude upward from the first inner bottom wall and the second inner bottom wall.

4. The high-efficiency pyrolysis apparatus according to claim 1, wherein the first pyrolysis furnace and the second pyrolysis furnace respectively include a detector, and wherein the detector is selected from the group including gas detectors, temperature detectors, and weight detectors.

5. The high-efficiency pyrolysis apparatus according to claim 1 further comprising a first recycling pipe, which is arranged between the fractional distillation device and the second pyrolysis furnace and used to recycle a residual fluid, which is not completely burned in the second pyrolysis furnace, back to the second pyrolysis furnace for recombustion.

6. The high-efficiency pyrolysis apparatus according to claim 1 further comprising a waste water collector, which interconnects with the fractional distillation device through a second recycling pipe and collects waste water generated by the fractional distillation device.

7. The high-efficiency pyrolysis apparatus according to claim 1 further a fluid supply device, which interconnects with the first pyrolysis furnace through a fluid pipe and supplies a thermal-conduction fluid to the first pyrolysis furnace, wherein thermal contact occurs between the thermal-conduction fluid and the first heater.

8. The high-efficiency pyrolysis apparatus according to claim 1 further comprising a fluid supply device, which interconnects with the fractional distillation device through a fluid pipe and supplies a cooling fluid to cool the fractional distillation device.

9. The high-efficiency pyrolysis apparatus according to claim 1 further comprising a collector, which is connected with the first pyrolysis furnace and interconnects with a top of the first chamber, wherein a driving assembly turns the first pyrolysis furnace upside down, and residues inside the first pyrolysis furnace gravitationally fall into the collector.
